(19) United States
(12) Patent Application Publication
(10) Pub. No.: US 2025/0287934 A1
(43) Pub. Date: Sep. 18, 2025

(54) METHOD OF FUNGICIDAL TREATMENT TO HARVESTED CROPS

(71) Applicant: SYNGENTA CROP PROTECTION AG, Basel (CH)

(72) Inventors: Christopher Glen CLEMENS, Greensboro, NC (US); Nagarajan RAMALINGAM, Greensboro, NC (US)

(73) Assignee: SYNGENTA CROP PROTECTION AG, Basel (CH)

(21) Appl. No.: 19/113,734

(22) PCT Filed: Jul. 28, 2023
(86) PCT No.: PCT/EP2023/071008

§ 371 Date: Mar. 20, 2025

Related U.S. Application Data
(60) Provisional application No. 63/370,009, filed on Aug. 1, 2022.

(51) Int. Cl. A01M 7/00; A01N 43/48; A01N 43/90; A01P 3/00

(52) U.S. Cl. CPC A01M 7/0003; A01N 43/48; A01N 43/90; A01P 3/00

(57) ABSTRACT

Method for the cold fogging of a fungicidally-active compound to a post-harvest crop.

### TECHNICAL FIELD

The present disclosure relates generally to treatment of harvested crops, and more particularly to compositions and methods for treating post-harvested crops.

### BACKGROUND

As discussed in Stathers, T et al. in “A scoping review of interventions for crop post-harvest loss reduction in sub-Saharan Africa and South Asia.” Nat Sustain 2020, 3, 821-835, by 2050, the global population is expected to reach 9.7 billion people. Such an increase would require a 60% increase in food production compared with 2005-2007 levels. As such, it is recognized that reducing post-harvest losses of food crops is a critical component of sustainably increasing agricultural productivity.

Indeed, post-harvest loss of crops not only results in the loss of the valuable crop, but also the inputs (e.g., water, energy, labor, etc.) required to produce and distribute the crop. Given the substantial scale of post-harvest loss, reducing post-harvest loss can help: (1) create more sustainable and resilient food systems, and (2) reduce greenhouse gas emissions. In fact, reducing post-harvest loss can further optimize agricultural productivity and increase the incomes of small-scale food producers and associated value-chain actors. Accordingly, there remains a need for methods of protection against post-harvest loss of crops.

### SUMMARY

Embodiments include a method of cold fogging a composition having about 1% to about 20%, by weight percent, of a first fungicidally-active compound, about 1% to about 90%, by weight percent, of water, and at least one filler, to a pile or stack of harvested crop.

### BRIEF DESCRIPTION OF DRAWINGS

FIGS. 1A and 1B illustrate volume median diameter (VMD) of cold fogged formulations.

FIGS. 2A and 2B illustrate residue amounts of agrochemicals from cold fogging and conventional spraying.

FIG. 3 is an illustrative image of a typical storage unit for post-harvest potatoes.

### DETAILED DESCRIPTION

Before certain embodiments are described in greater detail, it is to be understood that this disclosure is not limited to embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

As used herein, the term “about” when referring to a measurable value such as an amount, a temporal duration, and the like, is meant to encompass variations. Such variations, however, are dependent on the specific component referred to and the context as understood by a person of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Methods and materials similar or equivalent to those described herein can also be used in the practice or testing of the present disclosure; representative illustrative methods, and materials are now described.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

The term agrochemical active ingredient includes compounds or ingredients registered as being biologically active against an agricultural pest. In general, agrochemical active ingredients include compounds listed in The Pesticide Manual, 12th edition, 2001, British Crop Protection Council. Agrochemicals include, but are not limited to selective herbicides, fungicides, other insecticides, bactericides, insect growth regulators, plant growth regulators, nematicides, molluscicides or mixtures of several of these preparations.

Generally, the disclosure provides compositions and methods of using and making a composition for post-harvest treatment. In some embodiments, compositions include a fungicidally-active compound, water, and a filler. These compositions can be used in cold fogging applications.

Current methods of post-harvest protection include techniques such as spraying or misting or thermal fogging compositions containing agrochemical active ingredients to harvested crops prior to or during storage of the crops. These techniques differ from cold fogging.

For instance, spraying or misting differs from cold fog based on at least droplet size, coverage, and accuracy. In general, spraying or misting physically varies from cold fogging in the size of the droplet used to apply the agrochemical active ingredient. While fog particles can have a diameter of less than about 50 microns, mist droplets tend to have a diameter larger than 50 microns. The difference in droplet size effects the droplets' ability to travel and cover an area.

Thermal fogging differs from cold fogging in at least the temperature of the composition. Whereas thermal foggers utilize heat to vaporize and fog compositions, cold foggers utilize pressure and other techniques to generate small droplet sizes. Due to the heat involved in thermal fogging, it may be disadvantageous to use agrochemical active ingredients which are heat sensitive. Furthermore, cold fogging can use existing water-based formulations without worrying about solvent/phytotoxicity effects, nor does cold fogging have the same explosivity risks that can come from thermal fogging operations.

The term fungicidally-active compound as utilized herein includes compounds active against phytopathogenic fungi. Fungicidally active compounds include those compounds that are room temperature (25° C.) solid and those compounds that are room temperature liquid. Compounds may include compounds in any number of classes, for example, triazole derivatives, strobilurins, carbamates (including thio- and dithiocarbamates), benzimidazoles (thiabendazole), N-trihalomethylthio compounds (captan), substituted benzenes, carboxamides, phenylamides, phenylpyrroles, and succinate dehydrogenase inhibitors.

Suitable triazole derivatives may include propiconazole, difenconazole, tebuconazole, tetraconazole and triticonazole. Suitable strobilurins include trifloxystrobin, azoxystrobin, kresoxim-methyl, pyraclostrobin, and picoxystrobin. In other examples, suitable carbamates include thiram. Suitable substituted benzenes include pentachloronitrobenzene (PCNB) and chlorothalonil. Suitable carboxamides include carboxin. Suitable phenylamides include metalaxyl; metalaxyl consisting of more than 70% by weight of the R-enantiomer; metalaxyl consisting of more than 85% by weight of the R-enantiomer; metalaxyl consisting of more than 92% by weight of the R-enantiomer; metalaxyl consisting of more than 97% by weight of the R-enantiomer; and mefenoxam (i.e., R-metalaxyl or metalaxyl-M). Suitable succinate dehydrogenase inhibitors include benzovindiflupyr.

Other suitable fungicidally-active compounds may include benomyl (also known as benlate), bitertanol, carbendazim, capropamid, cymoxanil, cyprodinil, ethirimol, fenpiclonil, fenpropimorph, fluquinconazole, flutolanil, flutriafol, fosetyl-aluminum, fuberidazole, guazatine, hymexanol, kasugamycin, imazalil, imibenconazole, iminoctadine-triacetate, ipconazole, iprodione, mancozeb, maneb, mepronil, metconazole, metiram, myclobutanil, nuarimol, oxadixyl, oxine-copper, oxolinic acid, pefurazoate, pencycuron, prochloraz, propamocarb hydrochloride, pyroquilon, silthiopham, tecnazene, thifluzamide, thiophenate-methyl, tolclofos-methyl, triadimenol, triazoxide and triflumizole.

In some embodiments, the fungicidally-active compound may include a combination of compounds. In one example, a mixture of fungicidally-active compounds includes fludioxonil and thiabendazole. In another example, a mixture of fungicidally-active compounds includes fludioxonil and azoxystrobin. In another example, a mixture of fungicidally-active compounds includes fludioxonil and propiconazole. In another example, a mixture of fungicidally-active compounds may include fludioxonil, mefenoxam and difenoconazole. In another example, a mixture of fungicidally-active compounds includes fludioxonil, mefenoxam, difenoconazole, and azoxystrobin.

Preferred agrochemical active ingredients include pydiflumetofen, azoxystrobin, fludioxonil, difenoconazole, thiabendazole, and cyclobutrifluram. Certain embodiments specifically include synthetic agrochemicals. However, other agrochemical active ingredients to be mentioned include ozone, peroxyacetic acid, hydrogen peroxide, chlorine dioxide, Pseudomonas syringae Strain ESC-10, and a peroxyacetic acid.

The amount of fungicidally-active compound may vary. In typical embodiments, the fungicidally-active component represent about 1% to about 50% by weight of the composition. Still in some examples, the fungicidally-active component may represent at least one of the following, about 1% to about 25% by weight of the composition; about 1% to about 20% by weight of the composition; about 1% to about 15% by weight of the composition; about 1% to about 10% by weight of the composition; and about 1% to about 5% by weight of the composition. In some embodiments, a first fungicidally active compound can be about 1% to about 20%, by weight percent. For example, the first fungicidally active compound can be from be about 5% to about 15%, or even about 6% to 12% by weight. The composition can further comprise a second fungicidally active compound, which is different from the first fungicidally active compound, and can also be present in about 1% to about 20%, by weight percent, for example about 5% to about 15%, or even about 6% to 12% by weight. Some embodiments include a third fungicidally active compound, where all three fungicidally active compound as different, and can also be present in about 1% to about 20%, by weight percent, about 5% to about 15%, or even about 6% to 12% by weight.

The amount of water in the composition may vary. In typical embodiments, the water represents about 1% to about 90% by weight of the composition. Still in some examples the water may represent at least one of the following, about 20% to about 80% by weight of the composition; about 30% to about 80% by weight of the composition; about 40% to about 80% by weight of the composition; about 50% to about 80% by weight of the composition; and about 60% to about 75% by weight of the composition. In many examples, the water will represent about 70% by weight of the composition.

In some embodiments, compositions may contain a filler. As used herein, filler refers to a component which stabilizes and homogenizes the agrochemical active ingredient throughout the fogging composition.

Fillers suitable for use may include at least one of 2-ethyl-1-hexanol, alpha-tocopherol, amyl acetate, decyl alcohol, dimethylformamide, dimethylsulfoxide, dipropylene glycol, ethylene glycol, glycerine, hexanol, isopropyl myristate, methyl isobutyl ketone, methyl oleate, N-methyl pyrrolidinone, octanol, oleic acid, oleyl alcohol, propylene glycol, p-xylene, triacetin. Others may prefer other fillers.

Filler amounts may vary, e.g. from about 0.1% to about 50% by weight of the treating composition; from about 5% to about 45% by weight of the treating composition; from about 5% to about 40% by weight of the treating composition; from about 5% to about 35% by weight of the treating composition; from about 5% to about 30% by weight of the treating composition; from about 5% to about 25% by weight of the treating composition; from about 5% to about 20% by weight of the treating composition; from about 5% to about 15% by weight of the treating composition; and from about 8% to about 12% by weight of the treating composition.

Certain composition embodiments as disclosed herein are particularly suitable for cold-fogging applications, and even more particularly, in many embodiments, as ready-to-fog (RTF) compositions for cold-fogging application. As used herein, RTF compositions include compositions that +do not require at least one of: a dilution prior to cold-fogging or a combination of active ingredient (e.g. by melting, heating or otherwise) to a carrier prior to fogging. As such, in many examples, RTF compositions disclosed herein may be contained within a storage and shipping container, and ready for fogging upon opening the storage and shipping container.

In embodiments where the composition is not an RTF, the composition can be diluted prior to cold fogging. Dilution rates can be greater than 1:0.5, 1:1, 1:2, 1:4, 1:8, 1:10, 1:14, 1:16, 1:25, 1:50, 1:64, 1:100, etc. The dilution rate can be selected based on the concentration of agrochemical in the composition and the desired residue on the post-harvest crop.

A variety of cold foggers can be used. Examples of cold foggers include Typhoon I, Maxi-Pro 2D, Versa Fogger, Nightstar, and Dyna Jet L30. Alternatively, the nozzle of the cold foggers can be affixed to the ceiling or wall of a structure used to store the post-harvest crop. These systems can be built to the specifications of the specific storage facility and crop being stored.

The compositions may be used to create a fog having a variety of particle sizes for uniform distribution during application of the active ingredient. Embodiments include compositions that can create fog having a particle size volume median diameter (VMD) in the range of about two to about twenty microns. In many examples, compositions may create fog having a particle size VMD in the range of about four to about twenty or about three to about ten microns. Particle sizes achievable by the instant disclosure, particularly particle sizes of about five to about ten microns, allowed for excellent distribution of the active ingredient to post-harvested crop. Particle size VMD may be determined using a Sympatec HELOS laser diffraction sensor at approximately 1 meter from the exit of the fogger.

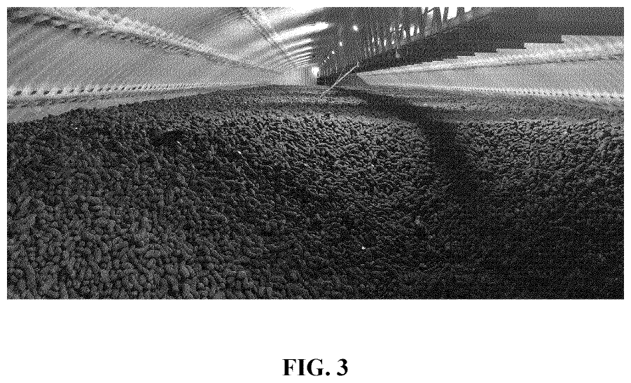

In some embodiments, the area where postharvest crops are stored is a large structure. For instance, the area can be capable of storing tons (kg) of crops, such as, at least 1, 2, 3, 4, 5, 6, 7, 8, 9, 10, 20, 30, 40, 50, 60, 70, 80, 90, 100, 200, 300, 400, 500, 600, 700, 800, 900, 1,000 or more tons. An illustrative image of an area for postharvest treatment is illustrated in FIG. 3.

In some examples, fillers may also be used to increase the visibility of the composition upon fogging. These fillers may be the same or different from fillers used to stabilize and homogenize the compositions. Increasing the visibility of the fogged composition may provide any number of benefits, including for example at least one of decreasing applicator exposure to a fogged composition or increasing contact of the fogged composition with post-harvested crops. For example, compositions may be fogged to create a visibility when measured by obscuration of light in the range of at least one of 20 to 70% Copt; 25 to 65% Copt; 30 to 60% Copt; 35 to 55% Copt; and 40 to 50% Copt. Copt measurements may be taken using Sympatec HELOS laser diffraction sensor at approximately 1 meter from the exit of the fogger.

Compositions as disclosed herein may also include other inert additives. Such additives include thickeners, flow enhancers, wetting agents, antifoaming agents, biocides, buffers, lubricants, drift control agents, deposition enhancers, adjuvants, evaporation retardants, freeze protecting agents, stabilizing metal salts or hydroxides, UV protecting agents, fragrances, and the like.

Embodiments also include the methods of treating postharvest fruits or vegetables, for example, by applying the compositions disclosed herein. As noted, preferred application methods will include application by cold-fogging, e.g. as described above.

In many embodiments, target crops to be protected may include any variety of fruit or vegetable. Exemplary postharvest material includes apples, pears, plums, grapes, peaches, almonds, cherries, strawberries, raspberries, blackberries, bananas, spinach, lettuce, asparagus, cabbages, carrots, onions, tomatoes, potatoes, sugar beets, paprika, beans, lentils, peas, soybeans, marrows, cucumbers, melons, oranges, lemons, limes, grapefruit, mandarins, etc. It should be apparent that this listing does not represent any limitation of targeted crops.

The following examples are illustrative of the invention but are not intended to limit its scope. In the below examples, and throughout the specification, where not indicated % generally refer to w/w.

### EXAMPLE 1

Agrochemical formulations were tested in both spray and cold fogging applications to compare the quality of the spray and to determine the amount of active compound on the leaves. Four different treatments were sprayed at two different dilutions:

| Product | Applic. Method | Dilution | Applic. Volume | | Applic. Method |
|---|---|---|---|---|---|
| Palladium | Foliar - Dilute | 6 oz/100 gal | 100 | GPA | Foliar - Traditional |
| | Foliar - Concentrate | 6 oz/3 gal | 2.3 | GPA | Foliar - Cold Fog |
| Mural | Foliar - Dilute | 7 oz/100 gal | 100 | GPA | Follar - Traditional |
| | Foliar - Concentrate | 7 oz/3 gal | 2.3 | GPA | Foliar - Cold Fog |
| Segovis | Foliar - Dilute | 2.6 oz/100 gal | 100 | GPA | Foliar - Traditional |
| | Foliar - Concentrate | 2.6 oz/3 gal | 2.3 | GPA | Foliar - Cold Fog |
| Mainspring GNL | Foliar - Dilute | 8 oz/100 gal | 100 | GPA | Foliar - Traditional |
| | Foliar - Concentrate | 8 oz/3 gal | 2.3 | GPA | Foliar - Cold Fog |

GPA = gallons per acre.

Palladium® is a commercially available fungicidal composition sold by Syngenta® having 37.5% w/w cyprodinil and 25% w/w fludioxonil.

Murak® Fungicide is a commercially available fungicidal composition sold by Syngenta® having 30% w/w azoxystrobin and 15% w/w benzovindiflupyr.

Segovis® Fungicide is a commercially available fungicidal composition sold by Syngenta® having 18.7% oxathiapiprolin.

Mainspring® GNL Insecticide is a commercially available insecticidal composition sold by Syngenta® having 18.66% w/w cyantraniliprole.

For traditional treatments: for each treatment, 3 organic grown Begonias were placed in a row in the spray chamber 20 inches below the spray nozzle. The plants were sprayed with each treatment through a 8001 nozzle at 40 psi and 3 mph. One hour after application, leaves were collected from each of the three plants and placed in separate Ziploc bags labeled with ID and sent for residue analysis.

For fog treatments: fog application was conducted inside a tent in order to contain the fog for several hours after application. The plants were sprayed with each treatment through a Dramm nozzle at 20 psi from a fixed location 6 feet above the plants. To avoid contamination, the tent walls were covered with plastic sheets that were replaced after each treatment. One treatment was sprayed per day and leaves were collected several hours after application. No ventilation system was used in order to prolong circulation of the droplets. The tent was sealed during the application to avoid losses. Calculations were done based on the Dramm manual operational instructions. Two different collector types where taken: (1) Begonia leaves (3 replicates, leaves) collected, frozen and processed by analytical; active ingredient quantified in ppb; and (2) Filter Paper (3 replicates), active ingredient quantified in ppb.

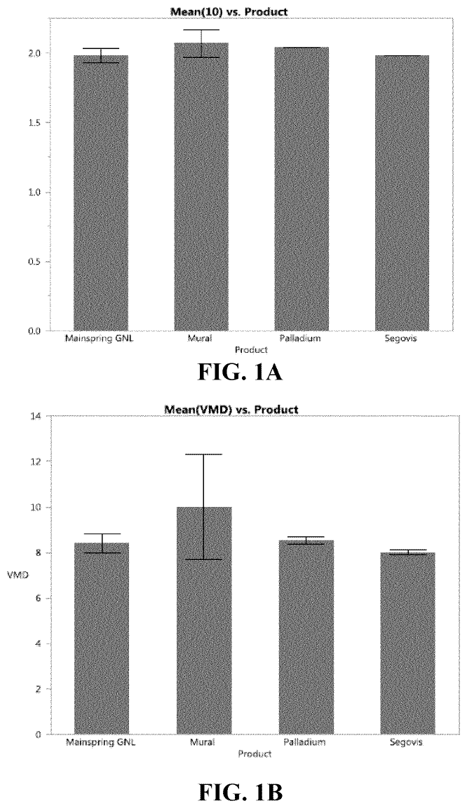

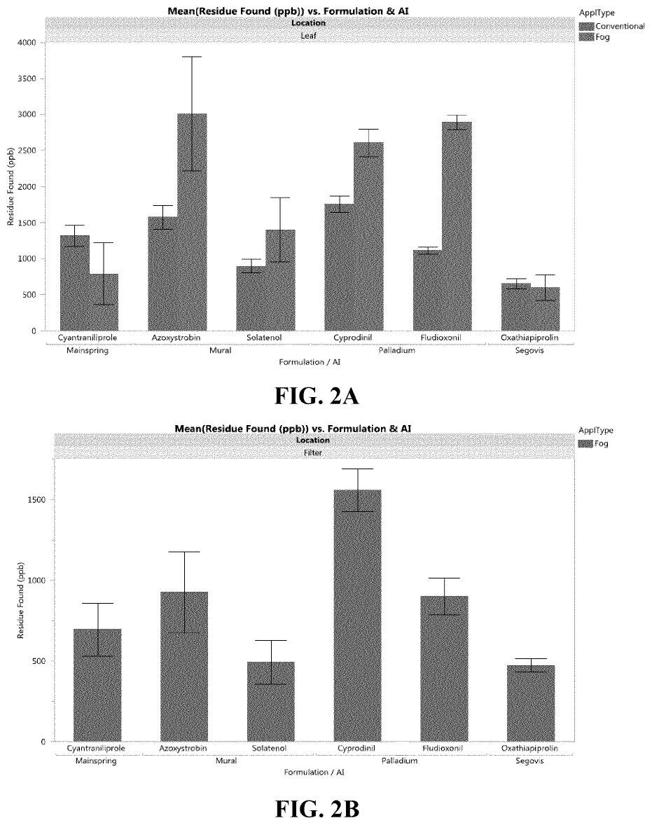

Mean (VMD) and Mean (10) results are provided in FIGS. 1A and 1B. As illustrated Mean (VMD) was kept below 15 microns. The residue results are provided in FIGS. 2A and 2B illustrated residue results of fogging residues were as good as, if not equal to or greater than, than spray application, and with less water being used.

### EXAMPLE 2

Stadium® fungicide (12.51% w/w azoxystrobin, 12.51% w/w fludioxonil, and 9.76% w/w difenoconazole commercially available from Syngenta) was cold fogged by initially diluting 1 part Stadium® to 14 parts water and then further diluting the mixture by injecting it into a carrier stream of water. Residues were measured on a pile of potatoes (about 5 potatoes high) and filter paper. The particle size measured from the cold fogger was ˜30 microns and was not able to move through a pile of potatoes well. Residues measured from potatoes on the bottom of the pile were less than 10% of those measured at the top of the pile. In addition, the treatment resulted in wet potatoes. After 24 hours, potatoes on top of the pile were still visibly wet while most on the bottom were dry.

### EXAMPLE 3

The parameters of the cold fogging machine can be altered to achieve smaller particles, as illustrated in Example 1, to achieve fog particles of, e.g., 15 microns. Achieving a smaller droplet size can allow the droplets to move through the pile or stack of post-harvest crops, such as potatoes, more efficiently.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A method comprising cold fogging a composition comprising:
1% to 20%, by weight percent, of a first fungicidally-active compound;
1% to 90%, by weight percent, of water; and
at least one filler,
to a pile or stack of a harvested crop.

2. The method of claim 1, wherein the first fungicidally active compound includes at least one compound chosen from a triazole derivative, a strobilurin, a carbamate, a benzimidazole, a N-trihalomethylthio compound, a substituted benzene, a carboxamide, a phenylamide, a phenylpyrrole and a succinate dehydrogenase inhibitor.

3. The method of claim 1, wherein the first fungicidally active compound is selected from fludioxonil, mefenoxam, metalaxyl, difenoconazole, propiconazole, thiabendazole, and azoxystrobin.

4. The method of claim 1, wherein the harvested crop is potatoes.

5. The method of claim 1, wherein the cold fogging comprises forcing the composition through an orifice at high pressure.

6. The method of claim 5, wherein the forcing is by direct compression of the composition by a pump.

7. The method of claim 5, wherein the high pressure is 2500-3000 psi.

8. The method of claim 5, wherein the forcing is by compressed air.

9. The method of claim 1, wherein the cold fogging comprises generating ultra-sonic waves to atomize the composition.

10. The method of claim 1, wherein the cold fogging comprises generating kinetic energy to atomize the liquid.

11. The method of claim 1, wherein the cold fogging comprises cold fogging directly into a storage chamber of the harvested crop.

12. The method of claim 1, wherein the cold fogging comprises introducing the fog into a plenum chamber of large volume slow moving air mass.

13. The method of claim 1, wherein the temperature of the composition is 33° F. to 95° F. (0° C. to 35° C.) in the cold fogger.

14. The method of claim 1, wherein the fog particles have a volume median diameter of 4 to 20 microns.

15. The method of claim 1, wherein the fog particles have a volume median diameter of 5 to 10 microns.

16. The method of claim 1, further comprising mixing a concentrated composition comprising the first fungicidally-active compound to form the composition.

17. The method of claim 1, further comprising configuring a cold fogger apparatus to generate fog having a uniform dose composition with a volume median diameter of 4 to 20 microns by adjusting at least one of:
(a) the ratio of the first fungicidally-active compound, the water, and the at least one filler,
(b) the temperature of the composition during fogging,
(c) the flow rate of the composition in the cold fogger apparatus,
(d) the energy source for atomization, and
(e) the orifice size of a nozzle on the cold fogger apparatus.

18. The method of claim 1, wherein cold fogging comprises diluting the composition.
